(19) United States
(12) Patent Application Publication
(10) Pub. No.: US 2025/0196991 A1
(43) Pub. Date: Jun. 19, 2025

(54) DEVICE FOR THE AUTOMATIC LOCKING OF AN ADJUSTABLE MECHANICAL SYSTEM

(71) Applicant: LATECOERE, Toulouse (FR)

(72) Inventor: Philippe Gri, Saint Genies Bellevue (FR)

(73) Assignee: LATECOERE, Toulouse (FR)

(21) Appl. No.: 18/849,723

(22) PCT Filed: Mar. 16, 2023
(86) PCT No.: PCT/EP2023/056744

§ 371 Date: Sep. 23, 2024

(30) Foreign Application Priority Data
Mar. 24, 2022 (FR) FR2202604

(51) Int. Cl. B64C 1/14

(52) U.S. Cl. CPC B64C 1/1407

(57) ABSTRACT

An automatic locking device for an adjusting member having an external element (2), integral with a mechanical system, provided on its internal wall with a thread and intended to receive a movable internal element (1) provided with an external thread (11) and an internal bore (10), the internal (1) and external (2) elements cooperating by screwing to ensure adjustment of the position of the system, includes a push-button (3) slidably housed in the bore (10) of the inner element (1), covering a deformable spring pin (4) provided with lateral legs which are retained in longitudinal slots (12) formed opposite one another through the wall of the inner element (1) and which, in the relaxed position of the pin, lock into notches (20) formed on the inner wall of the outer element (2).

### CROSS REFERENCE TO RELATED APPLICATION

This application is a national stage entry of PCT/EP2023/056744 filed Mar. 16, 2023, under the International Convention and claiming priority over French Patent Application No. FR2202604 filed Mar. 24, 2022.

### FIELD OF THE INVENTION

The invention relates to a device for automatically locking and/or blocking a mechanical system in its final adjustment position. The invention also relates to a mechanical system equipped with this device.

More particularly, this invention applies to mechanical systems which position, of at least some of its components, can be reversibly modified by means of a threaded adjusting member and which requires to be locked at the end of adjustment. Such systems are, for example, sashes (doors, hatches, etc.) whose position relative to a frame must be adjusted, before or after assembly, by means of an associated adjusting member in order to ensure correct opening and closing kinematics and a satisfactory final seal.

### BACKGROUND OF THE INVENTION

Traditionally, threaded elements used to adjust mechanical systems are locked, for example, by means of locknuts screwed onto the element, split pins, lock wires, bending washers, etc.

However, in certain situations, the space available in the environment of the adjustment element is insufficient to correctly mount and/or maneuver the associated locking device, which is designed to secure adjustment operations, particularly when it is necessary to use specific tools which is often cumbersome.

### SUMMARY OF THE INVENTION

In this context, the main aim of the invention is to automatically ensure the mechanical locking or blocking of a threaded adjusting element by means of a simple manual tool and with very little space required around this element.

This aim is achieved, according to the invention, by means of an automatic locking device for an adjusting member comprising an external element, integral with a mechanical system, provided on its internal wall with a thread and intended to receive a movable internal element provided with an external thread and an internal bore, said internal and external elements cooperating to ensure, by screwing, an adjustment of the position of said system, characterized in that it comprises a push-button slidably housed in said bore of the inner element, covering a deformable spring-loaded pin provided with lateral legs which are retained in longitudinal slots screwed through the wall of said inner element and which, in the relaxed position of the pin, lock into notches provided on the inner wall of said outer element.

According to an advantageous feature of the invention, the push-button has an internal concavity with a cylindrical-conical profile, the wall of which rests on the lateral legs of the pin.

According to another feature of the device of the invention, the lateral legs of the pin form a shoulder between distal end strands that are non-parallel and disjoint and proximal end strands that join to form a closed loop.

According to a specific embodiment, the bore of the internal element is closed at its proximal end by a plug against which the lateral legs of the pin rest.

In this variant, the locking device of the invention comprises a helical spring mounted between the base of the push-button and the cap, and at the center of which extend the lateral legs of the pin.

Preferably in this case, the device comprises a washer which is arranged between the base of the push-button and the end turn of the spring, and which is provided with a hole through which the proximal end strands of the pin pass.

In another embodiment, the push-button has a cylindrical body with a head of reduced cross-section which projects out of the bore when the pin is in the detent position.

In yet another embodiment of the device, the push-button body extends longitudinally on either side of the slots in the inner element, and features gills through which the lateral legs of the pin pass.

In yet another variant, the inner bore opens outwards at its distal end via a hexagonal-section cavity.

As an alternative, the inner bore opens outwards at its distal end at the center of a hexagonal-section operating nut integral with said inner element.

Preferably, the push-button head then protrudes into the center of the operating nut.

According to the invention, the external element is designed with an even number of notches for locking the pin's lateral legs.

According to a specific variant of the device, the pin is made of two articulated parts. In this case, the device is equipped with a dynamic wedge featuring lateral recesses which receive the lateral legs of the articulated pin and which is arranged in contact with the base of the push-button.

Another object of the invention is a mechanical system provided with an adjustment member comprising an external element, integral with the system, provided on its internal wall with a thread and intended to receive a movable internal element provided with an external thread and an internal bore, said internal and external elements cooperating to ensure, by screwing, an adjustment of the position of said system, characterized in that said system is equipped with a device as defined above to ensure the locking of its adjustment.

Yet another object of the invention is the use of the device defined above for locking the position adjustment of a sash in its frame.

A final object of the invention is an aircraft equipped with at least one locking device with the above features for adjusting the mounting position of the doors on the fuselage.

The invention's locking device makes it possible to ensure, automatically and with standard and therefore economical means, an efficient, stable and precise locking of the member usually used to adjust the position or fasten various components of even complex mechanical systems.

Thanks to the invention's device, a setting lock can be obtained easily and quickly despite the presence of a very narrow system environment, where the limited space available generally precludes the use of heavy, cumbersome tools.

Furthermore, with the invention, and in the event that the locking has not been completely finalized, any subsequent relative displacement between the threaded peripheral nut forming the outer element and the threaded inner element would, in fine, be automatically blocked by the engagement of the shoulder of the pin's lateral legs in one of the adjacent, following or preceding notches, due, in particular, to the pin's specific elasticity and shape memory. As a result, the invention provides enhanced setting security.

The invention is applicable to any type of mechanical system incorporating a threaded adjusting or fastening member which it is necessary or useful to lock. Thus, the invention can be applied, in particular, to any opening, for example, an aircraft or hangar door, and to any type of building or mobile machine.

### BRIEF DESCRIPTION OF THE FIGURES

Further data, features and advantages of the present invention will become apparent from the following non-limited description, with reference to the appended figures which extend in a horizontal plane and represent, respectively:

FIG. 1 is a longitudinal sectional view of an adjusting member provided with a first embodiment of the device of the invention in locking position.

FIG. 2 is a longitudinal sectional view of the actuator of FIG. 1 with the device of the invention in the actuating position.

FIG. 3 is a perspective view of the external element integrated into the locking device according to the invention.

FIG. 4 a side view of the deformable pin of the locking device according to the invention in three situations, in the free state, integrated under tension in the locking device of the invention, respectively, in the locking position and in the adjustment position.

FIG. 5 is a perspective view of the push-button of the locking device according to the invention.

FIG. 6 is a cross-sectional view of the internal element adapted and integrated into the locking device according to the invention.

FIG. 7 is a partial perspective view of a second embodiment of the device of the invention in the locked position.

FIG. 8 is a partial perspective view of the device of the invention shown in FIG. 7 in the set position.

FIG. 9 is an exploded perspective view of a variant of the pin integrated into the locking device of the invention.

FIG. 10 is a longitudinal sectional view of another embodiment of the device of the invention featuring the pin variant of FIG. 9 in the locked position.

FIG. 11 is a longitudinal sectional view of the FIG. 10 device in the manually unlocked position.

FIG. 12 is a longitudinal sectional view of the device shown in FIG. 10 in the manual adjustment position.

FIG. 13 is a partial exploded perspective view of a variant of the device of the invention.

### DETAILED DESCRIPTION OF THE INVENTION

For greater clarity, identical or similar elements are marked with the same reference signs throughout the figures.

Naturally, the embodiments of the invention illustrated by the figures shown above and described below are given only as non-limiting examples. It is explicitly provided that different modes can be proposed and combined with each other to propose others.

The invention relates to the field of adjusting the position of a mechanical system by means of an adjusting member consisting of an internal threaded element cooperating by screwing with a complementary external threaded element integral with the system. In particular, the invention concerns the locking of this adjustment in order to secure the final position of the mechanical system over time.

Such mechanical systems are typically opening systems, for example, doors whose position relative to a frame must be adjusted to obtain correct closing and opening and satisfactory sealing.

This objective of automatically locking and securing the position and orientation of a door is crucial when the door is mounted in a frame in the fuselage of an aircraft, and is therefore subject to high stresses.

However, the invention can also be applied to the locking of actuators integrated into mechanical fastening or assembly systems.

In the following description, the term “distal” refers to the side outside the internal element of the actuator, while the term “proximal” refers to the opposite side, i.e. the side in the immediate vicinity of the system or integral with the system. Consequently, the term “intermediate” or “median” corresponds to a position between the distal and proximal positions.

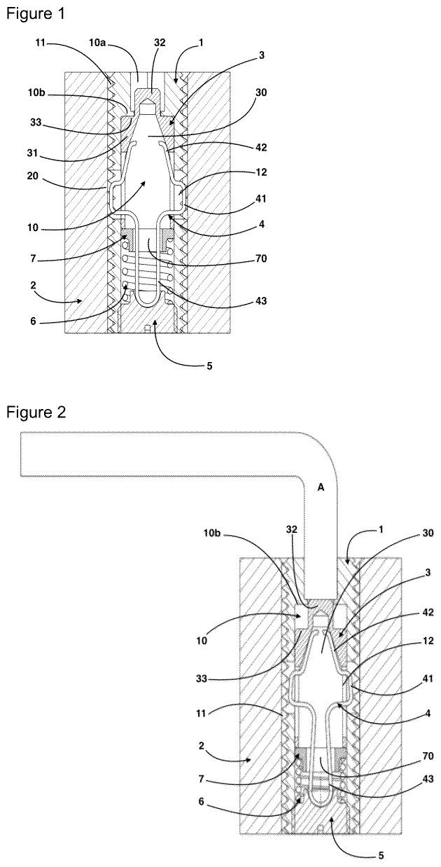

As illustrated, in particular, by FIGS. 1 and 2 in cross-section, the locking device of the invention is intended to equip an adjusting member comprising a cylindrical internal element 1 possibly connected to a frame and provided, in the conventional manner, with an external thread 11 and an internal bore 10. Such an element consists, for example, of a threaded, recessed rod or a hollow screw, as illustrated in detail in FIG. 6.

This male element 1 is designed to be inserted into a threaded female external element 2 (made, for example, in the form of a peripheral nut) which is integral with or in engagement with a mechanical system (not shown here) to ensure, by screwing, an adjustment of the position of this system relative to a frame or the adjustment of the assembly of various components of this system. Element 1 thus forms the movable part of the system's adjusting member, while element 2 forms its fixed part. However, in a variant of the invention not shown, these elements 1, 2 could be reversed so that element 1 forms the fixed part and element 2 the movable part.

It so happens that, in some configurations, the space available in the environment of the mechanical system is very limited, or is encumbered by the presence of structural obstacles. Under these conditions, it becomes very difficult to carry out the setting lock, in particular, when it is necessary to use tools of large dimensions and/or to carry out rotational movements of these tools with a large amplitude.

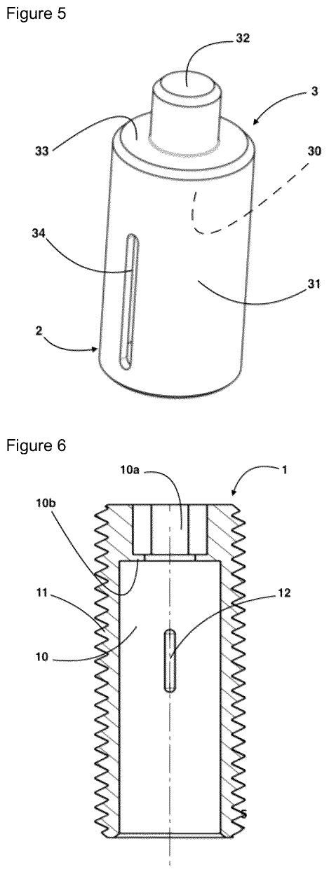

In this context, the invention provides automatic locking by means of a device comprising a push-button 3 (shown in detail in FIG. 5), slidably housed in the bore 10 of the internal threaded element 1 and capping a pin 4 (shown in detail in FIG. 4) having two lateral legs. Preferably, pin 4 is elastically deformable and forms a shape-memory spring.

The push-button 3 has an internal concavity 30 with a cylindrical-conical or at least partially conical profile, the wall of which rests on the distal end strands 42 of the lateral legs of the elastic pin 4.

This push-button 3 has a cylindrical body 31 with a head 32 of reduced cross-section (FIG. 5) which protrudes outside bore 10 in the resting (locking) position of pin 4, as illustrated in FIG. 1. In this position, the shoulder 33 of push-button 3 at the junction between body 31 and head 32 is in abutment with an internal recess 10b of bore 10 of internal threaded element 1.

The lateral legs of the pin 4 have intermediate strands forming a shoulder 41 which is intended to face longitudinal slots 12 made through the wall of the internal threaded element 1.

This intermediate shoulder 41 has a partially rectangular profile with a longitudinal section which is substantially parallel to the common axis of the threaded element 1 and the nut 2. As for the proximal end strands 43 of pin 4, they join to form a closed loop, as shown in FIGS. 1, 2 and 4, of which only the portion connecting with intermediate strands 41 is deformed. A variant of the invention in which the lateral legs of the pin 4 are independent and joined at the level of the strands 43 will be described later and illustrated, in particular, in FIG. 13.

In the relaxed position of pin 4, and therefore in the locking position of the device, shoulder 41 widens and engages and locks in notches 20 on the inner wall of the outer peripheral element 2, driven by the distal end strands 42, which spread after adjustment when push-button 1 is released.

In the embodiment illustrated in FIGS. 1 and 2, the body 31 of the push-button 3 extends longitudinally on either side of the slots 12 in the threaded element 1 for retaining the lateral legs of the pin 4. In this case, the push-button 3 also has, laterally and on either side of the body 31, gills 34 for the passage of the shoulder 41 of the lateral legs of the pin 4, as illustrated in FIG. 5. The respective dimensions of the slots 12 and the openings 34 are adapted to the dimensions of the shoulder 41 of the pin 4 to allow it to move during transitions between the setting and locking phases.

Once enclosed in the bore 10 of the internal threaded element 1, the pin 4 is preferably under slight tension, even in the locked position, due, on the one hand, to the bearing contact with the wall of the cavity 30 of the push-button 3 and, on the other hand, to the transverse compression of the side arms imposed by the dimensions of the notches 20 of the external element 2.

The strands 42 at the distal ends of pin 4 are non-parallel and disjointed, so that pressing on the head 32 of push-button 3 causes these strands to slide in a guided manner against the conical wall of cavity 30, bringing them together and folding back the shoulder 41 located on the intermediate strands. FIG. 4 shows the different states of the elastic pin 4, respectively, in the free state, in the locking position in the device and in the adjustment position. Preferably, pin 4 is made of spring-loaded stainless-steel wire.

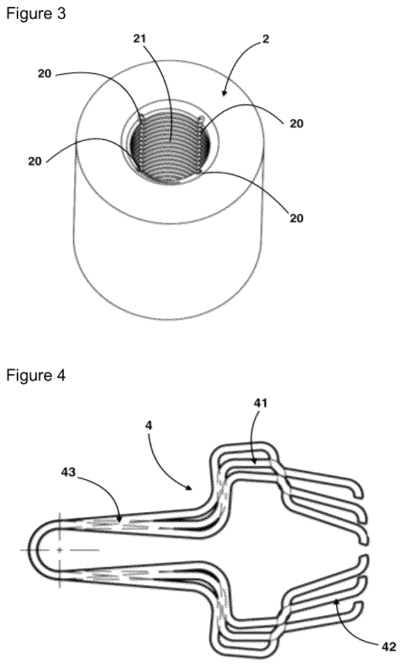

According to the invention, the outer peripheral element 2 has an even number of notches 20 for locking the lateral legs of the pin 4. In the embodiment shown in FIG. 3, the outer element 2 has two pairs of diametrically opposed notches 20 made as longitudinal grooves in the threads of tapping 21. However, the number of pairs of notches 20 depends on the desired setting accuracy. At the same time, it is not necessary to thread the internal element 1 (11) along its entire length.

To enable adjustment, the push-button 3 is moved axially in translation inside bore 10 to control the tension of pin 4 to ensure unlocking.

This operation is carried out by jointly pressing the push-button 3 from outside the bore 10 and rotating the internal threaded element 1 using a manual tool (such as an Allen key A—FIG. 2). The translatory movement of knob 3 in bore 10 thus results in the compression of pin 4. Given the specific shape and elasticity of pin 4, this forced deformation causes the lateral legs of pin 4 (and principally that of the intermediate strands forming shoulder 41) to retract towards the inside of internal threaded element 1.

The intermediate strands then escape from the notches 20, freeing the male threaded element 1, which can then rotate freely in the female external element 2, which remains fixed.

Once the setting has been made, removal of the manual tool A causes the lateral legs to relax and extend outwards (due to the elasticity and shape memory of the pin 4), returning automatically into the notches 20 of the external element 2. At the same time, push-button 3 returns to its initial position, abutting against the necking 10b of bore 10.

If, however, the intermediate strands 41 of the side arms are not directly opposite the notches 20, a slight rotation of the internal threaded element 1 by a few millimetres (without pressing the knob 3) will bring these strands opposite the nearest notches 20 and finalize the locking. The final locking is visually confirmed when the knob 3 is lifted and brought to a stop in bore 10.

Consequently, in the event of the locking not being completely effected, any subsequent relative displacement between the external element 2 and the internal element 1 would be stopped automatically on passage of the shoulder 41 opposite the next or previous notch 20, thanks to the elasticity of the pin 4.

Thus, in the locking position, the intermediate shoulder 41 of the pin 4 forms an obstacle which interposes itself in the threaded connection between the male element 1 and the female element 2, preventing these two parts from rotating relative to each other, as shown in the position illustrated in FIG. 1.

According to a specific embodiment, the bore 10 of the internal element 1 is closed at its proximal end by a plug 5 against which the proximal end strands 43 of the pin 4 bear.

Still in this embodiment, the locking device of the invention further comprises a helical compression spring 6 mounted between the base of the push-button 3 and the plug 5, and at the center of which extend the proximal end strands 43 of the pin 4. The spring 6 holds the push-button 3 in a distal position, and in abutment against the shoulder 10b of the bore 10, thus helping the resilient pin 4 to return to its relaxed locking position, its lateral arms remaining wedged in the two facing notches of the external element 2.

Preferably, the device comprises a washer 7 which is arranged between the base of the push-button 3 and the end turn of the spring 6. This washer 7 is provided with a hole 70 through which the proximal end strands 43 of the pin 4 pass, as illustrated in FIGS. 1 and 2.

According to a first variant of the device illustrated in FIGS. 1 and 2, the inner bore 10 opens onto the outside of the inner element 1 at its distal end via a cavity 10a with a hexagonal cross-section. Preferably, this cross-section corresponds to the gauge of an Allen key.

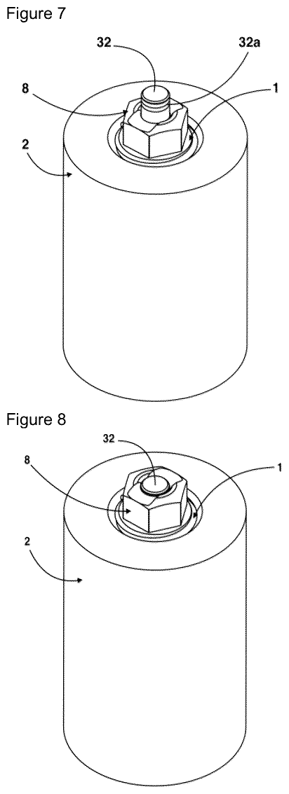

According to another variant illustrated in FIGS. 7 and 8, the inner bore 10 opens out of the inner element 1 at its distal end, at the center of a hexagonal-section operating nut 8 integral with the element 1. Preferably, the head 32 of the push-button 3 is retractable and then protrudes at the center of the operating nut 8. This head 32 is fitted with lines 32a providing an indication of locking activation.

In this variant, the operator would use an open-ended wrench or pipe wrench instead of the Allen wrench A used in FIG. 1. However, in other variants, the protruding head 32 could also have a bi-hexagonal cross-section or any other geometry suitable for cooperation with a hand tool. The retractable head 32 would be brought into a protruding position during the adjustment phase (FIG. 7) and would be retracted once the latter is complete to ensure its locking (FIG. 8).

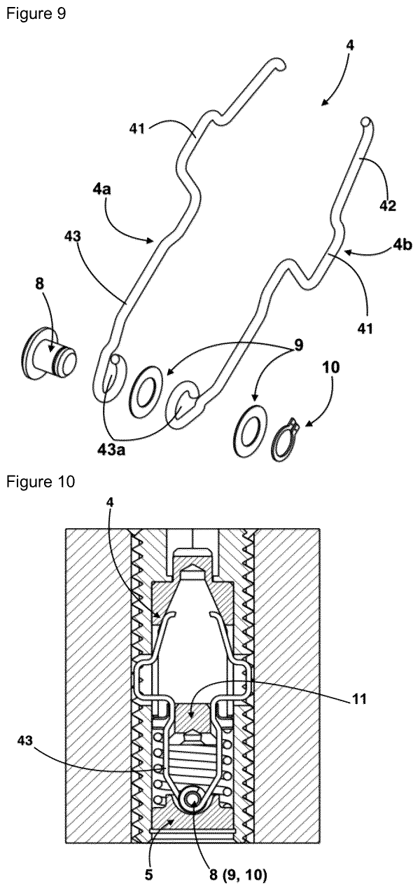

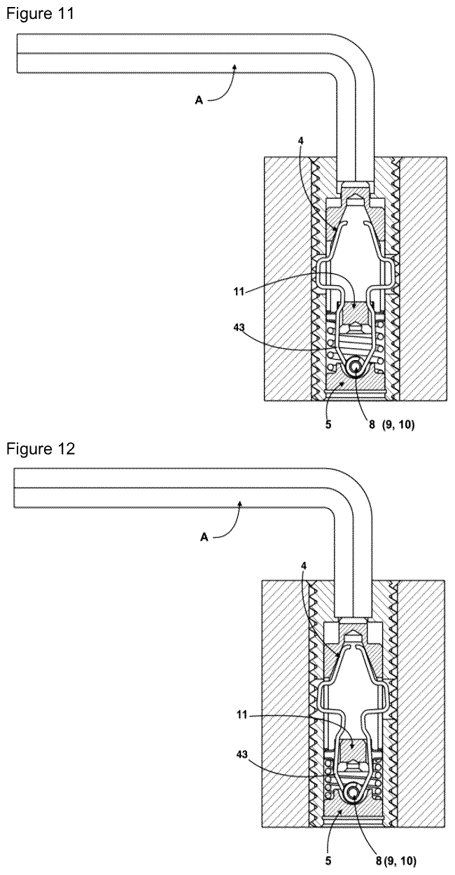

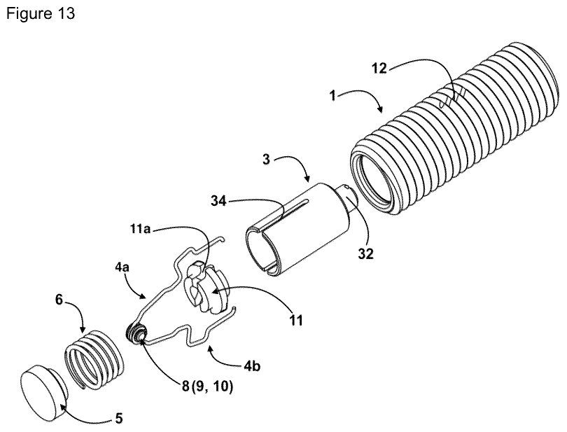

FIGS. 9 to 13 illustrate another embodiment of the locking device of the invention, with a variant of the pin 4 described above. This variant avoids the risk of deformation of the pin during installation in the device and during manual adjustment operations (for example, using an Allen key A).

This pin, shown in exploded perspective in FIG. 9, comprises independent lateral legs, here in the form of two parts 4a, 4b, which are joined together by means of a rivet 8 (or any other pivoting connecting member). The shank of this rivet is engaged in loops 43a provided at the end of the proximal end strands 43 of the branches and cooperates with a set of washers 9 and a retaining collar 10.

The rivet 8 thus forms a joint allowing the two parts 4a, 4b of the pin 4 to move relative to each other around the axis of rotation represented by the rivet 8 pin. The end of the articulated pin 4 always rests on the cap 5, as illustrated in FIGS. 10 to 12, in the locking, unlocking and adjustment positions respectively.

To hold the articulated pin 4 in place, the invention incorporates a dynamic wedge 11 between the spring 6 and the base of the push-button 3. This shim 11, which is made in one piece, can move in axial translation in the internal element 1 while not obstructing the slots 12. The shim 11 has two lateral grooves 11a (visible in FIG. 13) which receive the respective proximal end strands 43 of parts 4a, 4b of pin 4 in a sliding manner. These grooves 11a thus contribute to locking the pin 4 both during adjustment of the device and in the final locking position.

1. A self-locking adjusting device for a mechanical system comprising:
a movable internal element (1) and an external element (2) integral with the mechanical system and provided on an internal wall with a thread intended to receive the movable internal element (1) which is provided with an external thread (11) and an internal bore (10), wherein said internal (1) and external (2) elements cooperating by screwing to ensure adjustment of the position of said system,
an automatic locking device provided with a deformable pin (4) forming a spring and a push-button (3) housed in a sliding manner in said bore (10) of the internal element (1) and covering the deformable pin (4), the pin (4) being provided with lateral legs which are retained in longitudinal slots (12) screwed through the wall of the internal element (1) and which, in a relaxed position of the pin, lock into notches (20) provided on the internal wall of the external element (2),
wherein the push-button (3) comprising an internal concavity (30) with an at least partially cylindro-conical profile, the wall of which rests on the lateral legs of the pin (4)

2. The self-locking adjusting device according to claim 1, wherein the lateral legs of said pin (4) have a shoulder (41) between distal end strands (42) which are non-parallel and disjoint, and proximal end strands (43) which join to form a closed loop.

3. The self-locking adjusting device according to claim 1, wherein said bore (10) of the internal element (1) is closed at its proximal end by a plug (5) against which the lateral legs of the elastic pin (4) bear.

4. The self-locking adjusting device according to claim 3, further comprising a helical spring (6) mounted between the base of the push-button (3) and the plug (5) and at the center of which extend the lateral legs of the elastic pin (4).

5. The self-locking adjusting device according to claim 2, further comprising a washer (7) arranged between the base of the push-button (3) and the end turn of the spring (6) and which is provided with an orifice (70) through which the proximal end strands (43) of the pin (4) pass.

6. The self-locking adjusting device according to claim 1, wherein said push-button (3) has a cylindrical body (31) provided with a head (32) of reduced cross-section which projects outside the bore (10) in the detent position of the deformable pin (4).

7. The self-locking adjusting device according to claim 6, wherein the body (31) of said push-button (3) extends longitudinally on either side of the slots (12) of the inner element (1) and comprises gills (34) through which the lateral legs of the pin (4) pass.

8. The self-locking adjusting device according to claim 1, wherein said inner bore (10) opens to the outside of the inner member (1) at its distal end via a cavity (10a) of hexagonal cross-section.

9. The self-locking adjusting device according to claim 1, wherein said inner bore (10) opens to the outside of the inner member (1) at its distal end at the center of a hexagonal-section operating nut (8) integral with said inner member (1).

10. The self-locking adjusting device according to claim 6, wherein that the head (32) of the push-button (3) projects centrally from the operating nut (8).

11. The self-lock adjusting device according to claim 1, wherein said outer member (2) has an even number of notches (20).

12. The self-locking adjusting device according to claim 1, wherein said pin (4) is made in two articulated parts (4a, 4b).

13. The self-locking adjusting device according to claim 12, further comprising a dynamic wedge (11) provided with lateral grooves (11a) receiving the lateral legs of the articulated pin (4) and which is arranged in contact with the base of the push-button (3).

14. A mechanical system comprising the self-locking adjusting device according to claim 1.

15. (canceled)

16. An aircraft equipped with at least one self-locking adjusting device according to claim 1 for adjusting the mounting position of the doors in a frame on the fuselage.
